(19) United States
(12) Patent Application Publication
(10) Pub. No.: US 2013/0339153 A1
(43) Pub. Date: Dec. 19, 2013

(54) CUSTOMIZATION OF MULTIMEDIA

(71) Applicants: Sanjeev K. Mishra, Sunnyvale, CA (US); Nitya Narasimhan, Hopewell Junction, NY (US)

(72) Inventors: Sanjeev K. Mishra, Sunnyvale, CA (US); Nitya Narasimhan, Hopewell Junction, NY (US)

(73) Assignee: GENERAL INSTRUMENT CORPORATION, Horsham, PA (US)

(21) Appl. No.: 13/517,642

(22) Filed: Jun. 14, 2012

(51) Int. Cl. G06Q 30/02

(52) U.S. Cl. 705/14.66

(57) ABSTRACT

Disclosed are methods and apparatus for providing customized multimedia content to a user. Multimedia content is provided to a further user. The multimedia content comprises non-customizable, non-advertisement primary content and a customizable advertising opportunity. The further user may customize the advertising opportunity to produce customized multimedia content, which may then be sent, or shared with the user (for consumption by that user). Customization may include selecting an advertisement and including the selected advertisement in the advertising opportunity or selecting an advertising policy for the advertising opportunity. The advertisements (or policies) may be based on preferences (e.g., likes, dislikes, hobbies, interests) of the user.

### FIELD OF THE INVENTION

The present invention is related generally to providing customized multimedia content.

### BACKGROUND OF THE INVENTION

Many conventional advertising models (where a content provider dictates the advertising strategy) are showing signs of weakness. In contrast, advertising strategies that put a consumer in control of his advertisement experience are showing improved effectiveness. Typically, advertising models that allow for this consumer control are focused on allowing consumers to customize their own viewing/advertisement experiences.

Also, it is becoming increasingly difficult to track a consumer's interests or preferences. In particular, it is becoming increasingly difficult to track a consumer's purchase-related behaviour, as related purchases may occur in different domains.

The social group of a particular consumer (e.g., that consumer's friends and family, etc.) tend to be aware of that consumer's interests, preferences, and needs.

It is known that consumers share multimedia content (e.g., via social networking websites, etc.) between themselves.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic illustration (not to scale) showing a multimedia presentation;

FIG. 2 is a schematic illustration (not to scale) of an example network;

FIG. 3 is a schematic illustration (not to scale) of a sender device;

FIG. 4 is a schematic illustration (not to scale) of a receiver device;

FIG. 5 is a process flow chart showing certain steps of an embodiment of a process in which a sender customizes the multimedia presentation; and

FIG. 6 is a process flowchart showing certain steps of an embodiment of a process by which a receiver may consume one or more customized multimedia presentations.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

Embodiments of the invention include methods and apparatus for providing peer-to-peer message-based advertising between two different users of client devices (e.g., a TV, a computer, etc.). Firstly, uncustomized multimedia content may be provided to a first user (e.g., by an advertisement manager). The uncustomized multimedia content may comprise non-customizable primary content (e.g., a television program, a movie, a news broadcast, etc.). The uncustomized multimedia content may also comprise secondary content. The secondary content may be a customizable advertising opportunity (i.e., an advertising slot, or “ad slot”). The customizable advertising opportunity may be managed by the same entity that provides the uncustomizable media content. For example, the customizable advertising opportunity may be managed by an advertising manager. The customization of the secondary content may be limited (e.g., by the advertising manager) such that only certain customizations of the secondary content are allowed. For example, one or more options for customizing the secondary content may be provided for selection by the first user. The advertising opportunity may be such that one or more advertisements may be included in it. The first user may customize the advertising opportunity (using one or more customization options provided by the advertising manager) to produce customized multimedia content, which may then be sent, or shared with the second user (for consumption by that user). The first user may customize the advertising opportunity by, e.g., selecting an advertisement (e.g., from a set of recommended advertisements) and including the selected advertisement in the advertising opportunity or by selecting an advertising policy for the advertising opportunity specifying which advertisements may be selected for inclusion in the advertising opportunity. The advertisements (or policies) may be selected based on preferences (e.g., likes, dislikes, hobbies, interests) of the second user. Also, the first user may customize the advertising opportunity by changing the duration of the advertising opportunity, or by changing the position of the advertising opportunity in the multimedia content, or by excluding existing advertising opportunities from the multimedia content, or by including additional advertising opportunities in the multimedia content. Also, the first user may customize the advertising opportunity by including an annotation such that, when the customized multimedia content is consumed by the second user, the annotation may be provided for context or consumption by the second user.

Further embodiments of the invention may include methods and apparatus for presenting customized multimedia content to the user. If a plurality of differently customized versions of the multimedia content are received (e.g., by the user's end-user device, e.g., a computer, from a multiplicity of further users), the user may be presented with a plurality of different presentation options for viewing the received multimedia content. The user may select a presentation option and some or all of the customized multimedia content may be presented to the user in accordance with the selected presentation option. Example presentation options include: (i) an option to view one of the versions of the multimedia content (e.g., a randomly selected version or one selected by the user based on the identity of the further users), (ii) an option to view a multimedia presentation comprising the primary content and each of the differently customized advertising opportunities, (iii) an option to view the primary content and one or more customized advertising opportunities selected at random from the group of differently customized advertising opportunities; and (iv) an option to view by genre, rating, and other possible categories. An indication of the option selected by the user or an indication of the user's multimedia consumption may be provided for use by, for example, an entity that is remote from the end-user device.

Apparatus for implementing any of the below described arrangements, and for performing the method steps to be described below, may be provided by configuring or adapting any suitable apparatus, for example one or more computers or other processing apparatus or processors, or providing additional modules. The apparatus may comprise a computer, a network of computers, or one or more processors for implementing instructions and using data, including instructions and data in the form of a computer program or plurality of computer programs stored in or on a machine-readable storage medium such as computer memory, a computer disk, ROM, PROM, etc., or any combination of these or other storage media.

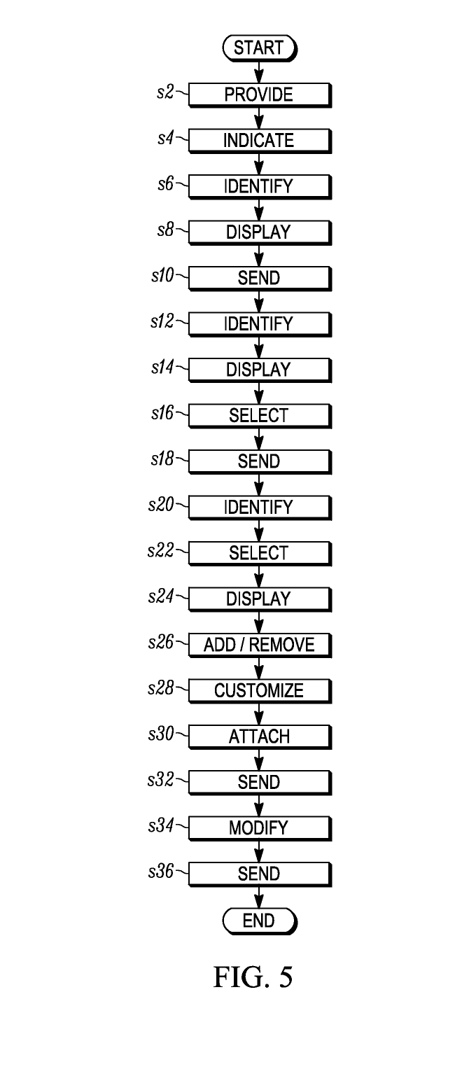

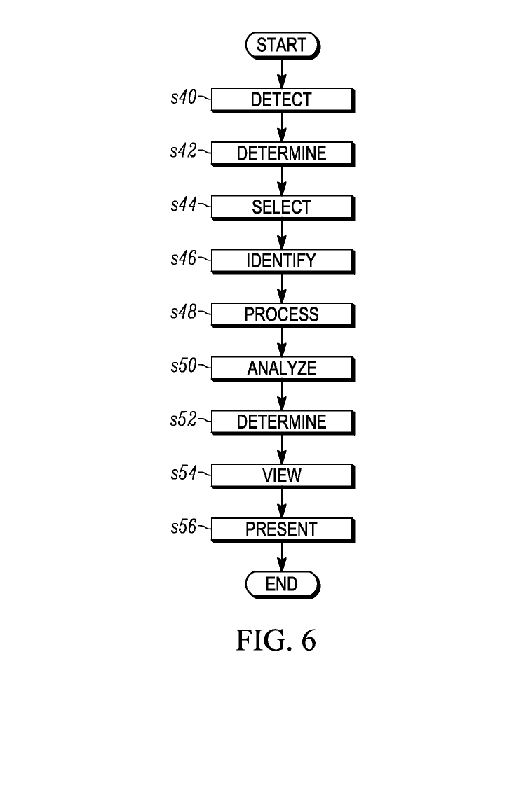

It should be noted that certain of the process steps depicted in the flowcharts of FIGS. 5 and 6 and described below may be omitted or such process steps may be performed in an order differing from that presented below and shown in those Figures. Furthermore, although all the process steps have, for convenience and ease of understanding, been depicted as discrete temporally-sequential steps, nevertheless some of the process steps may in fact be performed simultaneously or at least overlapping to some extent temporally.

Referring now to the Figures, FIG. 1 is a schematic illustration (not to scale) showing a multimedia presentation 100. The multimedia presentation 100 may be for consumption (e.g., watching, listening to, etc.) using any appropriate device (e.g., a computer) by a user of that device.

The multimedia presentation 100 runs from its start time 102 at time t=0 to its end time 104 at time t=T. The multimedia presentation 100 comprises primary content 106 and a plurality of advertising opportunities 108. An advertising opportunity 108 may be a “temporal advertising opportunity,” i.e., one that appears at some point in time in the multimedia presentation 100 and that separates portions of primary content 106. Alternatively, an advertising opportunity may be a “spatial advertising opportunity,” i.e., one that appears in the primary content 106 and that occupies an amount of screen space, e.g., a product placement.

The primary content 106 may be any type of media presentation or multimedia content, for example, a television program, a film, a news broadcast, etc. The primary content 106 is not itself an advertisement, i.e., an advertising campaign.

An advertising opportunity 108 is an opportunity, or slot, in the multimedia presentation 100 into which one or more advertisements (e.g., for products or services) may be inserted. An advertising opportunity 108 can exist outside of the multimedia presentation 100 or may be embedded within using known product placement techniques. When the multimedia presentation 100 is consumed by a consumer (i.e., played back by a consumer), the consumer is exposed to the advertisements associated with the advertising opportunities 108 (e.g., the advertisements in the advertisement opportunities 108 are shown to the consumer). An advertisement may be any form of content that presents a brand, brand-related message, or brand-related purchase opportunity. This can include the following types of advertisement: (i) standard advertisements which may include rich media content, that may form part of an advertising campaign, and that may be supplementary to the primary content 106 (e.g., advertisements may be overlaid on the primary content 106, or may be in pre-roll, post-roll, or interim advertisement slots), (ii) product placements which may include rich media content that are seamlessly embedded or integrated into the primary content 106 (e.g., advertisements may be overlaid on to a billboard shown in a scene from a TV program), and (iii) product purchase opportunities that can be associated with one of the preceding advertising types or can be presented in a stand-alone dialog (e.g., a companion application).

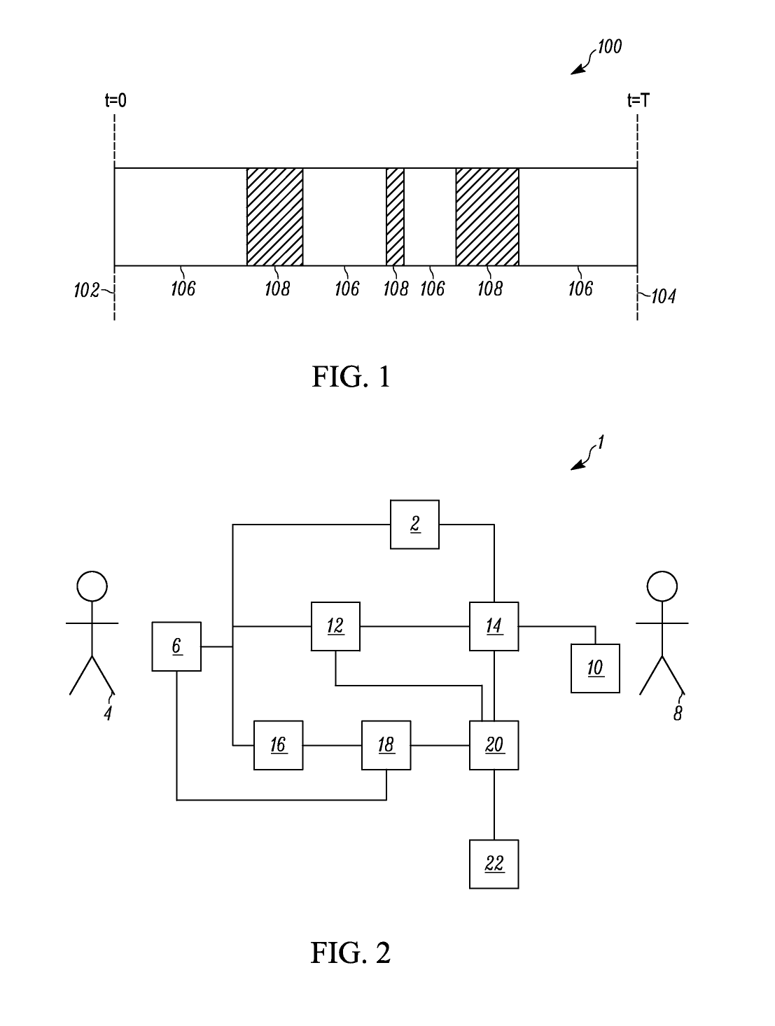

An advertisement policy may be defined on each of the advertising opportunities 108. For example, an advertisement policy for a particular advertising opportunity 108 may specify that only advertisements for a particular type of product (e.g., cars or food) may be inserted into that advertising opportunity 108. Also for example, an advertisement policy for a particular advertising opportunity 108 may specify that advertisements for a particular type of product (e.g., alcoholic drinks) may not be inserted into that advertising opportunity 108. An advertising opportunity 108 may be associated with one or more “default” advertisements which, if that advertising opportunity 108 is not modified to remove those default advertisements (e.g., by the sender 4 as described in more detail below with reference to FIG. 2), will be included in that advertising opportunity 108. An advertising policy may be defined across a multiplicity of advertising opportunities 108. If such a policy is modified, this modification may be directly applied to all advertising opportunities 108 that the advertising policy applied to.

An advertising opportunity 108 may be distinct from the primary content 106 (e.g., a commercial break in a TV program). Alternatively, an advertising opportunity 108 may be integrated with the primary content 106 (e.g., a banner advertisement or product placement that appears whilst a TV program is showing).

The advertisement opportunities 108 may be customized as described in more detail below with reference to FIG. 5.

FIG. 2 is a schematic illustration (not to scale) of an example of a network 1 in which an embodiment of a method of customizing an advertising opportunity 108 is implemented.

The network 1 comprises a content provider 2, a sender 4, a sender device 6, a receiver 8, a receiver device 10, a multimedia processor 12, a management module 14, a social graph service (SGS) module 16, a preference identification module 18, a selection module 20, and a database 22.

In this embodiment, the sender 4 customizes the multimedia presentation 100 for the receiver 8 (using the sender device 6) and sends the customized multimedia presentation 100 to the receiver 8 who can consume it on the receiver device 10.

The content provider 2 is the provider of the multimedia presentation 100. The content provider 2 is connected (e.g., via a wireless link or over the Internet) to the sender device 6 and to the management module 14 such that the multimedia presentation 100 may be sent between the content provider 2 and each of the sender device 6 and the management module 14. In this embodiment, the content provider 2 provides the multimedia presentation 100 including the non-advertisement primary content 106 and the specifications (i.e., positions, durations, advertising policies, default advertisements, etc.) of the advertisement opportunities 108. However, in other embodiments, another entity (e.g., the management module 14) may provide the specifications of the advertising opportunities 108 whilst the content provider 2 only provides the primary content 106.

The sender 4 is a human operator of the sender device 6.

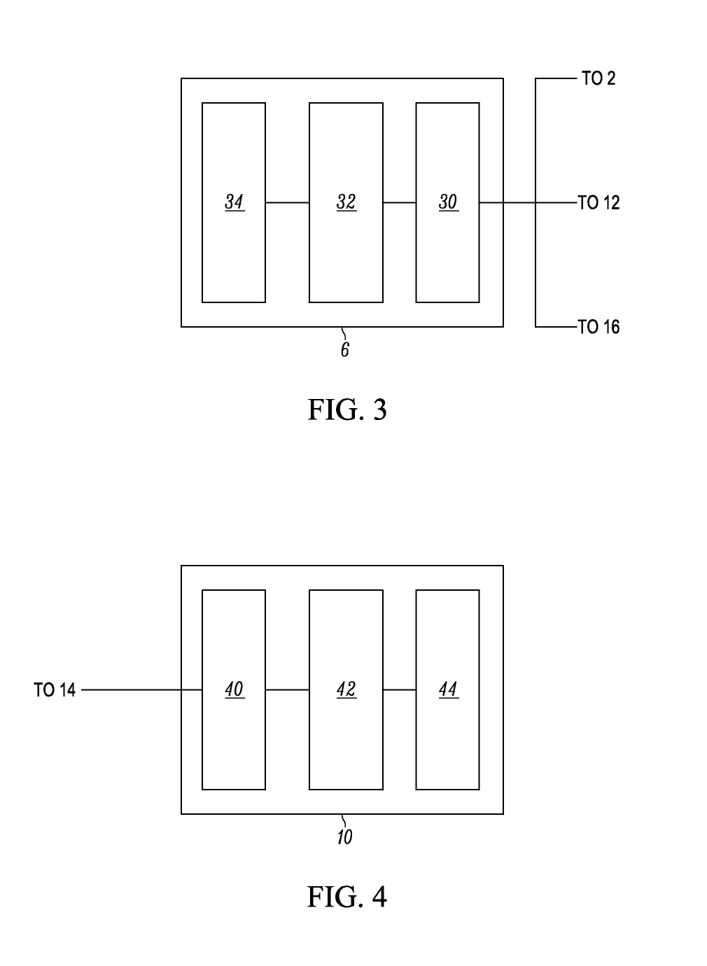

The sender device 6 is a conventional computer, e.g., a tablet computer, a “smartphone,” a laptop computer, etc. The sender device 6 is described in more detail below with reference to FIG. 3.

In addition to being connected to the content provider 2, the sender device 6 is connected (e.g., via a wireless link or over the Internet) to the management module 14 (via the multimedia processor 12). The sender 4 may customize (i.e., modify or change) the multimedia presentation 100 (as described in more detail below with reference to FIG. 5). This customized multimedia presentation 100 may be sent from the sender device 6 to the management module 14 via the multimedia processor 12. The sender device 6 is also connected to the SGS module 16 such that information may be transferred among the sender device 6 and each of the multimedia processor 12 and the SGS module 16.

The multimedia processor 12 is configured to process multimedia data passing between the modules to which the multimedia processor 12 is connected (i.e., the sender device 6, the management module 14, and the selection module 20). This is performed in order to provide useful multimedia context (e.g., advisory rating, keywords, genre, categories, etc.) that can be used by the preference identification module 18 or the further user to prioritize or to select preferences for the modifications.

The management module 14 may be used (e.g., by the content provider 2) to customize the multimedia presentation 100 and to manage the distribution of the multimedia presentation 100 (e.g., to the receiver device 10). This is described in more detail below with reference to FIG. 5. In addition to being connected to the sender device 6 (via the multimedia processor 12), the management module 14 is connected to the receiver device 10 (e.g., via a local area network such as MOCA or a wide area network) such that the multimedia presentation 100 may be sent from the management module 14 to the receiver device 10. Thus, the customized multimedia presentation 100 may be sent from the sender device 6 to the receiver device 10. Also, the management module 14 is connected to the selection module 20 such that information may be sent between the management module 14 and the selection module 20.

The receiver 8 is a human operator of the receiver device 10.

The receiver device 10 is a conventional computer, e.g., a tablet computer, a “smartphone,” a laptop computer, etc. The receiver device 10 is connected (e.g., via a local area network such as MOCA or a wide area network) to the management module 14 such that the customized multimedia presentation 100 may be received at the receiver device 10 from the management module 14. The receiver device 10 is described in more detail below with reference to FIG. 4.

The SGS module 16 is a module via which the sender device 6 may access information relating to the social graph of the sender 4. The social graph of the sender 4 is a graph linking the sender 4 to other consumers with whom the sender 4 has some sort of relationship, e.g., family, friends, colleagues, etc. The members of the sender's social graph are potential recipients of the customized multimedia presentation 100. In other words, the receiver 8 is a member of the sender's social graph. The accessing of the sender's social graph is described in more detail below with reference to FIG. 5. In addition to being connected to the sender device 6, the SGS module 16 is connected to the preference identification module 18.

The preference identification module 18 has access to information about the preferences (i.e., interests, likes, dislikes, etc.) of the members of the sender's social graph. In addition to being connected to the SGS module 16, the preference identification module 18 is connected to the selection module 20. Also, the preference identification module 18 may be connected to the sender device 6 such that the sender 4 may modify preferences accessible by the preference identification module 18.

The selection module 20 is connected to the preference identification module 18, the management module 14, the multimedia processor 12, and the database 22. The database 22 contains a plurality of different advertisements, i.e., the database 22 is in effect an advertisement repository. The advertisements stored in the database 22 cover a variety of different products and services. The selection module 20 is configured to select one or more advertisements from the database 22 depending upon one or more criteria. For example, the selection module 20 may select an advertisement depending on the preferences of a member of the sender's social graph that have been identified by the preference identification module 18. Also for example, the selection module 20 may select an advertisement depending on criteria set by the content provider 2 using the management module 14. Information relating to the selected advertisements may be sent from the selection module 20 to the sender device 6 (e.g., via the SGS module 16 and the preference identification module 18). Information relating to the selected advertisements may also be sent from the selection module 20 to the management module 14.

FIG. 3 is a schematic illustration (not to scale) of the sender device 6. The sender device 6 comprises a first transceiver 30, a first processor 32, and a first display 34. The first transceiver 30 is configured to transmit and receive information (e.g., the multimedia presentation 100). The first transceiver 30 is connected to the first processor 32. The first processor 32 is configured to process data that have been received by the sender device 6 and also process data that are for transmission from the sender device 6. The first processor 32 is connected to the first display 34. The first display 34 is for displaying information (e.g., the multimedia presentation 100) to the sender 4. The first display 34 may be a touch-screen display that the sender 4 may use to manipulate or modify the displayed information (e.g., the sender 4 may customize the multimedia presentation 100 using the first display 34). Use of the sender device 6 by the sender 4 is described in more detail below with reference to FIG. 5. In other embodiments, the sender device 6 may be a different type of device. Also, information may be manipulated using that device in a different way.

FIG. 4 is a schematic illustration (not to scale) of the receiver device 10. The receiver device 10 comprises a second transceiver 40, a second processor 42, and a second display 44. The second transceiver 40 is configured to transmit and receive information (e.g., the customized multimedia presentation 100). The second transceiver 40 is connected to the second processor 42. The second processor 42 is configured to process data that have been received by the receiver device 10. The second processor 42 is connected to the second display 44. The second display 44 is for displaying information (e.g., the customized multimedia presentation 100) to the receiver 8. The second display 44 is a touch-screen display that the receiver 8 may use to manipulate or modify the displayed information. Use of the receiver device 10 by the receiver 8 is described in more detail below with reference to FIG. 6. In other embodiments, the receiver device 10 may be a different type of device. Also, information may be manipulated using that device in a different way.

FIG. 5 is a process flow chart showing certain steps of an embodiment of a process in which the sender 4 customizes the multimedia presentation 100.

At step s2, the content provider 2 provides the multimedia presentation 100 to the sender device 6 and to the management module 14. The sender 4 may consume (e.g., watch) the multimedia presentation 100 using the sender device 6.

At step s4, the sender 4 indicates that he wishes to share the multimedia presentation 100. In this embodiment, the sender 4 wishes to share the multimedia presentation 100 with the receiver 8 (who is a member of the social graph of the sender 4). In other words, the sender 4 wishes to forward the multimedia presentation 100 on to the receiver 8 so that the receiver 8 may also consume the multimedia presentation 100 using the receiver device 10. This indication by the sender 4 may be made using any appropriate method. For example, the sender 4 may select a “share button” on the first display 34 of the sender device 6. Also for example, the intent to share may be detected by detecting a share activity event.

At step s6, the sender device 6 processes (using the first processor 32) the multimedia presentation 100 to identify the properties (i.e., positions, durations, specified advertising policies, etc.) of the advertisement opportunities 108 that are in the multimedia presentation 100.

The advertising opportunities 108 are defined in metadata carried with the primary content 106, and the properties of the advertisement opportunities 108 may be extracted from the multimedia presentation 100 itself. In other embodiments, the advertising opportunities 108 may be defined in metadata (associated with the primary content 106) that are stored, e.g., at the content provider 2, at the management module 14, or at a third-party server. In such embodiments, the properties of the advertisement opportunities 108 may be retrieved by the sender device 6.

At step s8, the identified properties of the advertisement opportunities 108 are displayed on the display 34 to the sender 4. This information may be displayed in any appropriate way. For example, the multimedia presentation 100 may be displayed as a timeline and the advertising opportunities 108 may be marked on that timeline (in a similar way to that shown in FIG. 1). Information relating to the advertisement opportunities (e.g., the duration, advertisement policies, default advertisements assigned to the advertising opportunities 108, etc.) may also be displayed.

At step s10, an indication that the sender 4 wishes to share the multimedia presentation 100 is sent from the sender device 6 to the SGS module 16 (e.g., via the first transceiver 30). The indication comprises information identifying the sender 4 (i.e., a sender ID).

At step s12, using the identity of the sender 4, the SGS module 16 identifies other consumers with whom the sender 4 has some kind of relationship, i.e., consumers with whom the sender 4 may wish to share the multimedia presentation 100. This may be done by the SGS module 16 selecting some or all of the members of the social graph of the sender 4. The receiver 8 is identified as a consumer with whom the sender 4 may wish to share the multimedia presentation 100.

At step s14, details of the consumers (including the receiver 8) that have been identified by the SGS module 16 are displayed to the sender 4 on the first display 34 of the sender device 6.

At step s16, from the displayed consumers, the sender 4 selects the receiver 8 to share the multimedia presentation 100 with. Other consumers may also be selected. The selection of the receiver 8 by the sender 4 may be displayed on the first display 34. The sender 4 may select a group of the displayed consumers to be recipients of the multimedia presentation 100.

In other embodiments, the consumers that the sender 4 selects to share the multimedia presentation 100 with may be selected in a different way. For example, the sender 4 may select a consumer from a list of “contacts” stored on the sender device 6.

At step s18, the selection of the receiver 8 by the sender 4 is sent from the sender device 6 to the preference identification module 18 (via the SGS module 16).

At step s20, the preference identification module 18 identifies the preferences (e.g., hobbies, interests, likes, dislikes, etc.) of the selected consumers (i.e., the receiver 8) and communicates these preferences to the selection module 20.

At step s22, using the received preference information, the selection module 20 selects, from the advertisements stored in the database 22, one or more advertisements. These advertisements may, for example, be selected to relate to the preferences of the receiver 8. For example, if the receiver 8 is interested in cars, then the selection module may select a number of car advertisements.

In other embodiments, instead of or in addition to being dependent on the preference information, the selection of advertisements by the selection module 20 may be dependent upon information sent to the selection module 20 from the management module 14 or from the multimedia processor 12. For example, the management module 14 may send information relating to properties of the advertisement opportunities 108 (e.g., duration, advertisement policy, etc.) to the selection module 20, and the selection of the advertisements by the selection module 20 may depend on this additional information. For example, a particular advertising opportunity 108 may have a duration of 5 seconds and an advertisement policy that specifies that food items should be advertised in that slot. The selection module 20 may use this information to only select, for that particular advertising opportunity 108, advertisements of 5 seconds or less that relate to food items.

At step s24, the selected advertisements (or information relating to the selected advertisements) are sent from the selection module 20 to the sender device 6 where they are displayed to the sender 4 on the display 34. The displayed selected advertisements may be thought of as recommendations or suggestions for advertisements to be included by the sender 4 in the multimedia presentation 100. The preferences of the receiver 8 that were used to select the selected advertisements may also be displayed to the sender 4.

Thus, at step s24 to the sender 4 may be displayed the following elements: (i) the advertising opportunities 108 and related information (as displayed at step s8), (ii) an indication of the selected recipients, i.e., an indication that the receiver 8 has been selected to receive the multimedia presentation 100 (as displayed at step s16), (iii) the preferences of the selected recipients, i.e., the preferences of the receiver 8 (as displayed at step s24), and (iv) the recommended advertisements for the receiver 8 and for the advertising opportunities 108 (as displayed at step s24).

At step s26, the sender 4 may, using the sender device 6, add new advertising opportunities 108 to the multimedia presentation 100. Also, the sender 4 may remove existing advertising opportunities 108 from the multimedia presentation 100. Also, the sender 4 may move (e.g., to a different position relative to the start and end times of the multimedia presentation 100) an existing advertising opportunity 108. Also, the sender 4 may edit an existing advertising opportunity 108 (e.g., by shortening or lengthening the duration of the advertising opportunity 108). This may be achieved by creating or authoring metadata, e.g., to specify a new advertising opportunity 108 or to remove an existing advertising opportunity 108. This may, for example, be done manually by the sender 4 using the sender device 6, e.g., the sender 4 may specify an advertising slot of a specific duration after a specific frame of the primary content 106. Also for example, the sender 4 may be provided with a selection of different advertising opportunities 108 that he may choose to include in the media presentation 100.

At step s28, the sender 4 may, using the sender device 6, customize some or all of the advertising opportunities 108. This may be performed depending upon the preferences of the receiver 8 or upon the recommended advertisements (that are displayed on the display 34).

The sender 4 may change the (default) advertising policy of an advertising opportunity 108. For example, the sender 4 may edit an advertising policy of an advertising opportunity 108 by including additional (or replacement) criteria. Such criteria may specify that advertisements of a certain type are allowed to be included in that advertising opportunity 108. Also, the criteria may specify that advertisements of a certain type are not allowed to be included in that advertising opportunity 108. The criteria may be specified using keywords or filters. The criteria may be specified depending on the receiver's likes, dislikes, or needs. The ability for the sender 4 to modify an advertising policy associated with an advertising opportunity 108 tends to advantageously provide a relatively high degree of flexibility to advertisers who are able to dynamically pick a new advertisement for the advertising opportunity 108 based on the sender's customization and on the context (i.e., time and location) in which the receiver 8 will view the multimedia presentation 100.

Also, the sender 4 may change the (default) advertisements associated with an advertising opportunity 108. For example, the sender 4 may remove an existing default advertisement from an advertising opportunity 108 and replace it with a new advertisement of his own choosing. The new replacement advertisement may be selected from the recommended advertisements that were selected by the selection module 20 and displayed to the sender 4 at step s24. Alternatively, the new replacement advertisement may be from somewhere else. The ability for the sender 4 to select the advertisement that is to be shown to the receiver 8 advantageously provides the sender 4 with a relatively high degree of control.

The sender 4 may store multiple modification metadata elements against the same advertising opportunity 108. Each of the modifications may have some context that can be used to determine if and when that modification should be used when the multimedia presentation 100 is consumed by the receiver 8. If the contexts are such that more than one modification is “eligible” to be used during consumption by the receiver 8, then the receiver device 10 may make an executive or receiver-assisted decision on which modification to use.

If the sender 4 is to share the multimedia presentation 100 with multiple different parties, for a given advertising opportunity 108, then the sender 4 may specify different advertising policies or advertisements for each of those parties (or groups of parties). For example, if the sender 4 is to share the multimedia presentation 100 with two different groups of people, then the sender 4 may edit the advertising opportunities 108 (including the specific advertisements and advertising policies associated with the advertising opportunities 108) so that they are different for each group of people. Thus, by performing a single share action, the sender 4 is able to provide different multimedia content to different parties.

At step s30, the sender 4 may attach a message to the multimedia presentation 100 (or to a portion of the multimedia presentation 100). This message may be such that when the multimedia presentation is received or consumed by the receiver 8, the message is provided (e.g., displayed) to the receiver 8. This message may for example be an explanatory message from the sender 4 explaining to the receiver 8 the nature of the multimedia presentation 100 or why the sender 4 has customized it in the way that he has. This message facility advantageously allows the sender 4 to add a “personal touch” to the multimedia presentation and also may be used to reassure the receiver 8 that the customized multimedia presentation 100 is not spam or junk-mail. Furthermore, the receiver 8 may use this message to make a decision on whether or not to consume the customized multimedia presentation 100.

Thus, a customized multimedia presentation 100 is produced by the sender 4.

At step s32, the customized multimedia presentation 100 is sent from the sender device 6 to the management module 14.

At step s34, the management module 14 may modify the multimedia presentation 100. This may be done such that the multimedia presentation is in accordance with the changes made by the sender 4 (at steps s26 and s28) and in accordance with any advertising policy or campaign specified by, e.g., the content provider 2 or by a third party (e.g., an advertiser). For example, where the sender 4 has specified a new advertising policy (but not specific advertisements) for an advertising opportunity 108, the management module 14 may select a new advertisement (e.g., using the selection module 20) that is in accordance with the new advertising policy and include that new advertisement into that advertising opportunity 108. The advertisements that are included in the multimedia presentation 100 by the management module 14 may depend on any criteria, such as the time or day, the location of the receiver 8, the type of the primary content 106, etc.

At step s36, the management module 14 sends the customized multimedia presentation 100 to the receiver device 10 for consumption by the receiver 8.

Thus a process in which the sender 4 customizes the multimedia presentation 100 is provided.

FIG. 6 is a process flowchart showing certain steps of an embodiment of a process by which the receiver 8 may consume one or more customized multimedia presentations 100 sent to the receiver device 10.

At step s40, the receiver device 10 detects that the customized multimedia presentation 100 (sent to it from the sender 4) has been received, i.e., the receiver device 10 detects that a media content item has been shared with the receiver 8.

At step s42, the receiver device 10 determines whether or not the received multimedia presentation 100 has already been received by the receiver device 10 (e.g., from a third party) at some earlier point in time.

For example, prior to receiving the customized multimedia presentation 100 from the sender 4, the receiver device 10 may have received another version of the multimedia presentation 100 (e.g., one that has been customized by a third party in a different way from how the sender 4 has customized the multimedia presentation 100). The receiver device 10 determines whether or not this is the case.

The (different) versions of the multimedia presentation 100 are identified, and a list of the identified versions may be displayed to the receiver 8 on the second display 44. In other words, if the receiver 8 has been sent multiple versions of the multimedia presentation 100 (that may have been customized differently), then each of these versions of the multimedia presentation 100 may be identified and displayed to the receiver 8, e.g., in the form of a list or a simple counter on the second display 44. A list may further provide indications of the distinct senders of that multimedia presentation 100. A list may be shown alongside the multimedia content (e.g., based on the existence of a multiplicity of modifications at that opportunity).

At step s44, using the receiver device 10, the receiver 8 may select some or all of the identified versions of the multimedia presentation 100. The receiver 8 selects the version or versions of the multimedia presentation 100 that he wishes to consume. For example, the receiver 8 may select for consumption only the most recent version of the multimedia presentation 100 (i.e., the receiver 8 may discard older versions). Also for example, the receiver 8 may select for consumption only versions of the multimedia presentation 100 that have been customized by certain senders (e.g., friends or family). Also for example, the receiver 8 may discard versions of the multimedia presentation 100 that they have previously consumed. In other embodiments, a policy may be applied by the receiver device 10 to automatically select only those versions of the multimedia presentation 100 that satisfy certain criteria. For example, such a policy may provide that only those customized multimedia presentations 100 that have been sent from one of the receiver's friends are automatically selected. Also for example, such a policy may automatically select only the most recently received customized multimedia presentation 100.

At step s46, the receiver device 10 identifies advertising opportunities 108 present in the selected versions of the multimedia presentation 100.

At step s48, the second processor 42 of the receiver device 10 processes the multimedia presentation 100 so that all of the different advertising opportunities 108 that have been identified at step s46 are accommodated. For example, the multimedia presentation 100 may be modified to include all of the different advertising opportunities 108 present in the versions of the multimedia presentation 100 that were selected by the receiver 8 at step s44. If a modification made by a sender 4 provided a (e.g., new) policy as opposed to a specific advertisement, then the second processor 42 may select an “appropriate advertisement” depending on the provided policy. Selection of an appropriate advertisement may comprise taking into account redundant or conflicting modifications. For example, if two different senders both modify the multimedia presentation 100 to include the same advertisement, then the second processor 42 may decide that, in the final presentation to the receiver 8, that advertisement should only be shown once. Also for example, if two different senders both modify the multimedia presentation 100 to include the same advertising policy, then the second processor 42 may decide that, in the final presentation to the receiver 8, two different advertisements (one under each sender) should be shown. Also for example, if two different senders both modify the multimedia presentation 100 to include conflicting advertisements or conflicting policies, then the second processor 42 may decide that this conflict should be presented to the receiver 8 for resolution. The receiver's decision may be recorded in analytics. An advertiser may use these analytics to improve the effectiveness and breadth of advertising delivery even after senders have customized it.

At step s50, the second processor 42 of the receiver device 10 analyses the multimedia presentation 100 to detect conflicts or multiple-choices for each of the advertising opportunities 108. Any of the modifications, advertisements, or advertising opportunities 108 may be discarded by the receiver device 10, e.g., depending on a policy set by the receiver 8. The receiver device 10 may also resolve conflicts between modifications made by a single sender or multiple senders. Resolution of conflicts may be made on a per sender version of the content. This advantageously tends to provide finer grained analytics on which specific sender or policy was least aligned to the recipient (and tends to be indicative of degrees of familiarity of sender with the recipient interest).

At step s52, one or more consumption options (e.g., viewing options) for the selected versions of the customized multimedia presentation 100 are determined by the second processor 42. These consumption options may be dependent on the analysis carried out at step s50. These consumption options may be displayed to the receiver 8 on the second display 44.

A first example consumption option may be an option in which no preference as to which of the selected versions of the customized multimedia presentation 100 to consume is expressed. In this option, the version of the customized multimedia presentation 100 to be provided for consumption may, for example, be selected at random. Alternatively, in this option, for each advertising opportunity 108, a customization of that advertising opportunity 108 may, for example, be selected at random from the customizations provided in the selected versions of the customized multimedia presentation 100. Alternatively, the version of the customized multimedia presentation 100 to be provided for consumption may be selected according to some third-party preference (e.g., preference of the content provider 2 or an advertiser).

A second example consumption option may be the option to consume all of the selected versions of the customized multimedia presentation 100. In such an option all available modifications and choices for each advertising opportunity 108 may be provided for consumption. For example, at each advertising opportunity 108, each of the different versions of that advertising opportunity 108 may be displayed. Also for example, for each of the advertising opportunities 108, the receiver 8 may select which of the different versions of that advertising opportunity 108 to display. This selection may be performed dynamically by the receiver 8 as the multimedia presentation 100 is consumed. Alternatively, this selection may be specified by the receiver 8 a priori before the multimedia presentation 100 is consumed.

A third example consumption option may be an option to view a version of the multimedia presentation 100 in which the advertising opportunities 108 of each of the selected versions of the customized multimedia presentation 100 are combined in some way. This combining of advertising opportunities 108 may be performed using system intelligence to resolve conflicts and to create a single unified experience with minimal user input.

A fourth example consumption option may be a default consumption option. A default consumption option may be an option to consume the original (non-modified) multimedia presentation 100 without any sender-influenced perspectives.

At step s54, the receiver 8 selects a consumption option and consumes the multimedia presentation 100 according to the selected consumption option. Thus, the receiver 8 may consume a version of the multimedia presentation 100, the advertising opportunities 108 in which may have been customized by one or more senders using knowledge about the preferences of the receiver 8.

At step s56, the receiver 8 may be presented with an option to perform one or more follow-up actions, for example, an option to re-share the multimedia presentation 100, an option to send a response to the sender 4, an option to save the customized multimedia presentation 100, an option to buy a product advertised in the customized multimedia presentation 100, etc. The receiver 8 may perform any of the presented options. This feature advantageously tends to provide the capability to create better analytics on sender/receiver relationships and influences. Furthermore, it tends to be possible to better model the receiver's preferences based on the types of follow-up actions that are performed.

Thus, a process by which the receiver 8 may consume one or more customized multimedia presentations 100 sent to the receiver device 10 is provided.

The above described methods and apparatus advantageously tend to provide that advertisements in shared multimedia content can be tailored towards the recipients' preferences. The sender of the shared content is able to tailor the advertising or product placement associated with that shared content to suit the preferences or needs of his targeted recipients. This tailoring tends to be possible because the sender is aware of the recipients' preferences and needs with regards to brands and products. Also, this tailoring may be performed at the granularity of individual advertising opportunities within the content and can be further targeted at the granularity of a specific subset of the recipient group (including on a per-recipient level).

The customization of the multimedia presentation may advantageously involve addition, deletion, or replacement of advertisements, ad policies, or advertising opportunities. It is advantageously possible to constrain customizations options to choices provided by the content owner, advertiser, or a third party. The sender of the multimedia presentation may advantageously specify a reason per modification, where a reason may be shown to recipients as context. Also, the sender may advantageously specify the visibility or scope of their modifications and reasons.

The “sharing” of the primary content tends to be enhanced with the ability for the sender to customize any or all of advertisements included with that primary content.

The sender may be incentivized to take this effort using implicit or explicit motives. An example implicit motive is that the sender may want to customize the advertisements to remove offensive or inappropriate content based on the identity of the receiver. A further example implicit motive is that the sender may want to make the advertisements more relevant to the receiver because he wants to make the receiver's viewing experience more pleasant. An example explicit motive is that the sender may be rewarded for customizing the multimedia presentation. Example rewards include loyalty points, discounts on purchases, a cut of revenue from clicks on an advertisement, and user benefits. Furthermore, the sender tends to get a degree of control and influence over the downstream experience.

The above described methods and apparatus advantageously tend to provide for more timely and trusted targeted advertisements. Furthermore, the recipient tends to be more likely to consume the advertisements because: (i) he consumes content received from a known party (e.g., a friend or family member), (ii) he can see that the advertisement is more relevant to him thanks to the sender's knowledge of his preferences, and (iii) he may be intrigued by the choice made by the sender (e.g., to see a reason annotation or from curiosity to see how others perceive his preferences).

The above described methods and apparatus advantageously tend to provide that advertisements are tailored towards the recipients of those advertisements, thereby increasing their effectiveness. Furthermore, advertisers are able to acquire influence and interest analytics for downstream users based on both sender behaviors (e.g., advertisement selections, annotation text, etc) and recipient behaviors (e.g., whether the advertisement was consumed, which advertisements were preferred, etc.). Furthermore, information relating to product placement can expose purchase behaviors that may be hard to elicit via simple ad-watching behaviors. Also, advertisers tend to be able to get a better sense of advertisement efficiency (e.g., “click counts”).

If the sender replaces or edits the advertisement policy of an opportunity (as opposed to specifying a particular advertisement), then an advertiser may gain additional benefits in dynamic advertising updates that can further refine the targeting based on recipient context.

In view of the many possible embodiments to which the principles of the present invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

We claim:

1. A method of providing peer-to-peer message-based advertising, the method comprising:
providing, to a first user, multimedia content, the multimedia content comprising primary content, the primary content being non-customizable by the first user, and secondary content, the secondary content being a portion of the multimedia content in which one or more advertisements may be included, the secondary content being customizable by the first user;
providing, to the first user, one or more different customization options, each customization option corresponding to a different customization of the secondary content;
identifying a second user;
using an input from the first user, the input identifying one or more of the provided customization options, customizing the secondary content for consumption by the second user, thereby providing customized secondary content; and
providing, for consumption by the second user, the primary content and the customized secondary content;
wherein customizing the secondary content is in accordance with one or more customization options identified by the input; and
wherein customizing the secondary content comprises including, in the secondary content, one or more advertisements.

2. A method according to claim 1 wherein customizing the secondary content comprises:
selecting, for consumption by the second user, one or more advertisements; and
including, in the secondary content, the selected one or more advertisements.

3. A method according to claim 2 wherein customizing the secondary content comprises:
presenting, to the first user for selection, a plurality of advertisements;
selecting one or more of the presented plurality of advertisements; and
including, in the secondary content, the selected advertisements.

4. A method according to claim 3 wherein the plurality of advertisements presented to the first user have been selected for presentation to the first user based upon preferences of the second user, the preference having been specified by the second user.

5. A method according to claim 1:
wherein the secondary content is a portion of the multimedia content for which an advertising policy may be specified; and
wherein customizing the secondary content comprises:
indicating an advertising policy for the secondary content;
selecting one or more advertisements in accordance with the indicated advertising policy; and
including, in the secondary content, the selected one or more advertisements.

6. A method according to claim 5 wherein the step of indicating an advertising policy for the secondary content comprises:
presenting, to the first user for selection, a plurality of advertising policies; and
selecting, for consumption by the second user, one of the presented advertising policies.

7. A method according to claim 6 wherein the plurality of advertising policies presented to the first user have been selected for presentation to the first user based upon preferences of the second user, the preference having been specified by the second user.

8. A method according to claim 1 wherein customizing the secondary content comprises:
selecting a duration for the secondary content;
changing the duration of the secondary content to be equal to the selected duration; and
including one or more advertisements in the secondary content having the changed duration, thereby providing the customized secondary content.

9. A method according to claim 1 wherein customizing the secondary content comprises:
selecting a position of the secondary content in the multimedia content;
changing the position of the secondary content in the multimedia content to be the selected position; and
including one or more advertisements in the secondary content having the changed position, thereby providing the customized secondary content.

10. A method according to claim 1 wherein customizing the secondary content comprises:
including further secondary content in the multimedia content;
including one or more advertisements in the secondary content; and
including one or more advertisements in the further secondary content.

11. A method according to claim 1 further comprising including, in the multimedia content, an annotation such that, when the primary content and the customized secondary content are consumed by the second user, the annotation is provided for consumption by the second user.

12. A method according to claim 1 further comprising monitoring the second user's interaction with the provided primary content and customized secondary content.

13. A method according to claim 1 wherein providing, for consumption by the second user, the primary content and the customized secondary content comprises sharing with the second user using a peer-to-peer content sharing process the primary content and the customized secondary content.

14. A method of providing customized multimedia content to a user for consumption by that user, the method comprising:
receiving a plurality of different versions of multimedia content;
providing, for selection by the user, a plurality of different presentation options, each presentation option corresponding to a different multimedia presentation, each multimedia presentation comprising at least part of one or more of the different versions of the multimedia content; and
in response to a selection of a presentation option by the user, presenting for consumption by the user the multimedia presentation corresponding to the selected presentation option;
wherein each version of the multimedia content comprises the same primary content, the primary content being non-customizable multimedia content;
wherein each version of the multimedia content comprises a different secondary content;
wherein the secondary content of each version of the multimedia content comprises one or more advertisements; and
wherein the secondary content of each version of the multimedia content has been customized for the user by a further user.

15. A method according to claim 14 wherein the plurality of different presentation options comprise an option to present one of the received different versions of the multimedia content.

16. A method according to claim 14 wherein the step of providing, for selection by the user, a plurality of different presentation options comprises displaying to the user the identities of the respective further users.

17. A method according to claim 14 wherein the plurality of different presentation options comprise an option to present a multimedia presentation comprising the primary content and each of the different versions of the secondary content.

18. A method according to claim 14 wherein the plurality of different presentation options comprise an option to present a multimedia presentation comprising the primary content and one of the different versions of the secondary content selected at random from a group consisting of all of the different versions of the secondary content.

19. A method according to claim 14 further comprises providing, for use by an entity remote from the user, an indication of the multimedia presentation presented to the user, thereby allowing that entity to monitor multimedia consumption of the user.

20. A method according to claim 14 wherein receiving is performed via a peer-to-peer media content sharing process.
